(19) United States
(12) Patent Application Publication
(10) Pub. No.: US 2009/0013373 A1
(43) Pub. Date: Jan. 8, 2009

(54) Television Broadcast Receiving Device and Method of Receiving Television Broadcast

(75) Inventor: Masaki Iizuka, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/576,364

(22) PCT Filed: Jan. 13, 2006
(86) PCT No.: PCT/JP2006/300401

§ 371 Date: Mar. 30, 2007

(30) Foreign Application Priority Data
Jan. 13, 2005 (JP) 2005-006079

(51) Int. Cl. H04N 7/16

(52) U.S. Cl. 725/142

(57) ABSTRACT

The invention is to allow answering of a call without interrupting a broadcast program having high real-time information even when the call comes in during viewing of the program. A communication transmitting/receiving portion 12 detects a call transmitted from another terminal. When the call is detected by the call detection portion during televising of a television broadcast, a video/audio output portion 17 outputs, to a speaker 14 or a headphone 15, any one of sound of the television broadcast superimposed on a voice of the call, the television broadcast sound remaining after the call voice is muted, and the call voice remaining after the television broadcast sound is muted. In addition, the video/audio output portion 17 outputs images of the television broadcast received by a broadcast receiving portion 11 to a display 13.

### TECHNICAL FIELD

The present invention relates to a television broadcast receiving device and a method of receiving television broadcast, particularly relates to a television broadcast receiving device and a method of receiving television broadcast for controlling output of a television sound, a call voice, a television image and a transmission/reception image when a call and an image are transmitted/received to/from another terminal.

### BACKGROUND ART

One or more television broadcast receiving devices have been installed in each home. Mobile phones are wide spread because of the advantage of convenience. In a television broadcast receiving device according to the background art, when there was an incoming call to a mobile phone while a program is being broadcasted on the television broadcast receiving device, a viewer had to give up viewing the currently broadcasted television program until the call is completed, and had to give up viewing the program during the call inevitably.

Therefore, there has been disclosed a television broadcast receiving device having a technique for recording images and sound of a program from the start of a call to the end of the call in advance and playing back the recorded images and sound after the end of the call (see Patent Documents 1 and 2). More specifically, the television broadcast receiving device having the disclosed technique is a television broadcast receiving device having a built-in mobile phone. As soon as there is an incoming call in the mobile phone portion and answering the call is started, the television broadcast receiving device with the disclosed technique starts a process of recording coded image/sound data of a currently viewed program on a recording medium such as a hard disc, an SDRAM, etc. When the call is completed, this television broadcast receiving device reads the coded image/sound data from the recording medium while continuing the recording process, so as to play back the program retroactively to the image when the call started.

### Patent Document 1: JP-A-2002-77323

### Patent Document 2: JP-A-2003-111004

### DISCLOSURE OF THE INVENTION

### Problem that the Invention is to Solve

When there is an incoming call while a television broadcast is being viewed, the aforementioned television broadcast receiving device is designed to play back the program from the start of the call to the end of the call after the call is completed. For this reason, there is a circumstance that a broadcast program with high real-time information such as news, sports, etc. has to be interrupted inevitably even if the broadcast program is desired to be viewed without interruption.

The invention is accomplished in consideration of the aforementioned problem pertinent to the background art. An object of the invention is to provide a television broadcast receiving device and a method of receiving television broadcast by which answering a call is allowed without interruption of a broadcast program having high real-time information, even when the call comes in while the program is being viewed.

### Means for Solving the Problem

In order to solve the foregoing problem, the television broadcast receiving device according to the invention is configured to include: a broadcast image display portion which displays an image of a television broadcast; a call detection portion which detects a call transmitted from another terminal; and an audio output portion which outputs any one of sound of the television broadcast superimposed on a voice of the call, the television broadcast sound remaining after the call voice is muted, and the call voice remaining after the television broadcast sound is muted, when the call is detected by the call detection portion during televising of the television broadcast.

According to this configuration, a call can be answered without interrupting a broadcast program having high real-time information such as news, sports, etc. even when the call comes in during viewing of the program.

The television broadcast receiving device according to the invention is configured to further include: an audio specifying information storage portion which stores audio specifying information for specifying the sound/voice outputted by the audio output portion, wherein: the audio output portion outputs the sound/voice specified in the audio specifying information stored in the audio specifying information storage portion when the call is detected by the call detection portion.

The television broadcast receiving device according to the invention is configured to further include: a call voice storage portion which stores the muted call voice when the call voice is muted so that only the television broadcast sound is outputted by the audio output portion; and a call voice output request portion which requests the audio output portion to output the call voice stored in the call voice storage portion, wherein: upon reception of an output request from the call voice output request portion, the audio output portion outputs the call voice stored in the call voice storage portion.

According to this configuration, a muted call voice is outputted afterward so that an important matter from another terminal can be confirmed.

The television broadcast receiving device according to the invention is configured so that address directory information in which identification information of calling/called terminals is registered is stored in the audio specifying information storage portion while associated with the audio specifying information; and when a call from a terminal having a phone number registered in the address directory information stored in the audio specifying storage portion is detected by the call detection portion during televising of a television broadcast, the audio output portion outputs sound/voice specified in the audio specifying information associated with the address directory information in which the phone number is registered.

According to this configuration, a call voice of a calling/called party can be muted or not muted based on a phone number described in address directory information stored in advance so that a television broadcast can be viewed in accordance with importance degree of the calling/called party.

The television broadcast receiving device according to the invention is configured so that program information in which identification information of programs of television broadcasts is registered is stored in the audio specifying information storage portion while associated with the audio specifying information; and when a call from another terminal is detected by the call detection portion during televising of a television broadcast of a program registered in the program information stored in the audio specifying information storage portion, the audio output portion outputs the sound/voice specified in the audio specifying information associated with the program information in which the program is registered.

According to this configuration, a call voice of a calling/called party can be muted or not muted based on a program of a television broadcast described in program information stored in advance so that the television broadcast can be viewed in accordance with importance degree of the program.

The television broadcast receiving device according to the invention is configured to further include: a reception image display permission information storage portion which stores reception display permission information for specifying whether to display an image received from another terminal or not; a reception image detection portion which detects the image; and a reception image display portion which displays the image when the image is detected by the image reception detection portion during televising of a television broadcast and the reception image display permission information stored in the reception image display permission information storage portion designates display of the image.

According to this configuration, an image received during viewing of a television broadcast can be displayed or not displayed based on reception image display permission information stored in advance.

The television broadcast receiving device according to the invention is configured so that address directory information in which mail addresses are registered is stored in the reception image display permission information storage portion while associated with the reception image display permission information; and when an image received from a terminal having a mail address registered in the address directory information stored in the reception image display permission information storage portion is detected by the reception image detection portion during televising of a television broadcast and the reception image display permission information associated with the address directory information in which the mail address is registered designates display of the image, the reception image display portion displays the image.

According to this configuration, an image received during viewing of a television broadcast can be displayed or not displayed based on a mail address registered in address directory information stored in advance.

The television broadcast receiving device according to the invention is configured so that program information in which identification information of programs of television broadcasts is registered is stored in the reception image display permission information storage portion while associated with the reception image display permission information; and when the image is detected by the reception image detection portion during televising of a television broadcast of a program stored in the program information storage portion and the reception image display permission information associated with the program information in which the program is registered designates display of the image, the reception image display portion displays the image.

According to this configuration, an image received during viewing of a television broadcast can be displayed or not displayed based on the program of the television broadcast registered in address directory information stored in advance.

The television broadcast receiving device according to the invention is configured to further include: a transmission image display permission information storage portion which stores transmission image display permission information for specifying whether to display an image to be transmitted to another terminal or not; a transmission image detection portion which detects the image; and a transmission image display portion which displays the image when the image is detected by the transmission image detection portion during televising of a television broadcast and the transmission image display permission information stored in the transmission image display permission information storage portion designates display of the image.

According to this configuration, an image to be transmitted during viewing of a television broadcast can be displayed or not displayed based on transmission image display permission information stored in advance.

The television broadcast receiving device according to the invention is configured so that address directory information in which mail addresses are registered is stored in the transmission image display permission information storage portion while associated with the transmission image display permission information; and when an image to be transmitted to a terminal having a mail address registered in the address directory information stored in the transmission image display permission information storage portion is detected by the transmission image detection portion during televising of a television broadcast and the transmission image display permission information associated with the address directory information in which the mail address is registered designates display of the image, the transmission image display portion displays the image.

According to this configuration, an image to be transmitted during viewing of a television broadcast can be displayed or not displayed based on a mail address registered in address directory information stored in advance.

The television broadcast receiving device according to the invention is configured so that program information in which identification information of programs of television broadcasts is registered is stored in the transmission image display permission information storage portion while associated with the transmission image display permission information; and when an image to be transmitted to another terminal is detected by the transmission image detection portion during televising of a television broadcast of a program stored in the program information storage portion and the transmission image display permission information associated with the program information in which the program is registered designates display of the image, the transmission image display portion displays the image.

According to this configuration, an image received during viewing of a television broadcast can be displayed or not displayed based on the program of the television broadcast registered in address directory information stored in advance.

The television broadcast receiving method according to the invention is configured to have the steps of: displaying an image of a television broadcast; detecting a call transmitted from another terminal; and outputting any one of sound of the television broadcast superimposed on a voice of the call, the television broadcast sound remaining after the call voice is muted, and the call voice remaining after the television broadcast sound is muted, when the call is detected by the call detection portion during televising of the television broadcast.

According to this configuration, a call can be answered without interrupting a broadcast program having high real-time information such as news, sports, etc. even when the call comes in during viewing of the program.

The television broadcast receiving method according the invention is configured to further have the steps of: inputting the audio specifying information for specifying the sound/voice to be outputted, in order to store the voice in advance; and outputting the sound/voice stored in advance and specified in the audio specifying information, when the call is detected.

The television broadcast receiving method according to the invention is configured to further have the steps of: making a request for outputting of the call voice muted but stored in advance, after only the television broadcast sound is outputted with the call voice being muted; and outputting the call voice after the output request.

According to this configuration, a muted call voice is outputted afterward so that an important matter from another terminal can be confirmed.

The television broadcast receiving method according to the invention is configured so that when a call from a terminal with a phone number registered in address directory information which is stored in advance and which includes identification information of calling/called terminals is detected during televising of a television broadcast, sound/voice specified in the audio specifying information associated with the address directory information in which the phone number is registered is outputted.

According to this configuration, a call voice of a calling/called party can be muted or not muted based on a phone number described in address directory information stored in advance so that a television broadcast can be viewed in accordance with importance degree of the calling/called party.

The television broadcast receiving method according to the invention is configured so that when the call is detected during televising of the television broadcast of the program registered in program information which is stored in advance and which includes identification information of programs of television broadcasts, the sound/voice specified in the audio specifying information associated with the program information in which the program is registered is outputted.

According to this configuration, a call voice of a calling/called party can be muted or not muted based on a program of a television broadcast described in program information stored in advance so that the television broadcast can be viewed in accordance with importance degree of the program.

The television broadcast receiving method according to the invention is configured to further have the steps of: detecting an image received from another terminal; and displaying the image when the image is detected during televising of a television broadcast and reception display permission information which is stored in advance and which is provided for specifying whether to display the image received from the other terminal or not designates display of the image.

According to this configuration, an image received during viewing of a television broadcast can be displayed or not displayed based on reception image display permission information stored in advance.

The television broadcast receiving method according to the invention is configured so that when reception of an image transmitted by a terminal with a mail address registered in address directory information which is stored in advance and in which mail addresses are described is detected during televising of a television broadcast and the reception image display permission information associated with the address directory information in which the mail address is registered designates display of the image, the image is displayed.

According to this configuration, an image received during viewing of a television broadcast can be displayed or not displayed based on a mail address registered in address directory information stored in advance.

The television broadcast receiving method according to the invention is configured so that when reception of the image is detected during televising of a television broadcast of a program stored in program information which is stored in advance and in which identification information of programs of television broadcasts is registered, and the reception image display permission information associated with the program information in which the program is registered designates display of the image, the image is displayed.

According to this configuration, an image received during viewing of a television broadcast can be displayed or not displayed based on the program of the television broadcast registered in address directory information stored in advance.

The television broadcast receiving method according to the invention is configured so that when an image to be transmitted to another terminal is detected during televising of a television broadcast, and transmission image display permission information which is stored in advance and which is provided for specifying whether to display the image to be transmitted to the other terminal or not designates display of the image, the image is displayed.

According to this configuration, an image to be transmitted during viewing of a television broadcast can be displayed or not displayed based on transmission image display permission information stored in advance.

The television broadcast receiving method according to the invention is configured so that when an image to be transmitted to a terminal with a mail address registered in address directory information which is stored in advance and in which mail addresses are described is detected during televising of a television broadcast and the transmission image display permission information associated with the address directory information in which the mail address is registered designates display of the image, the image is displayed.

According to this configuration, an image to be transmitted during viewing of a television broadcast can be displayed or not displayed based on a mail address registered in address directory information stored in advance.

The television broadcast receiving method according to the invention is configured so that when an image to be transmitted to another terminal is detected during televising of a television broadcast of a program registered in program information which is stored in advance and which includes identification information of programs of television broadcasts, and the transmission image display permission information associated with the program information in which the program is registered designates display of the image, the image is displayed.

According to this configuration, an image received during viewing of a television broadcast can be displayed or not displayed based on the program of the television broadcast registered in address directory information stored in advance.

### EFFECT OF THE INVENTION

The invention can provide a television broadcast receiving device and a television broadcast receiving method by which answering a call is allowed without interruption of a broadcast program having high real-time information, even when the call comes in while the program is being viewed.

### BRIEF DESCRIPTION OF THE DRAWINGS

FIG. 1 A block diagram showing the configuration of a television broadcast receiving device according to an embodiment of the invention.

FIG. 2 A view showing display contents of a display in FIG. 1.

FIG. 3 A view showing information stored in an information storage portion in FIG. 1.

FIG. 4 A flow chart showing operation of the television broadcast receiving device according to the embodiment of the invention.

FIG. 5 A flow chart showing call processing in step S17.

FIG. 6 A flow chart showing reception image exclusive processing in step S19.

FIG. 7 A flow chart showing voice-attached reception image processing in step S21.

FIG. 8 A flow chart showing transmission image exclusive processing in step S23.

FIG. 9 a flow chart showing voice-attached transmission image processing in step S25.

### DESCRIPTION OF REFERENCE NUMERALS

11 broadcast receiving portion
12 communication transmitting/receiving portion
13 display
14 speaker
15 headphone
16 information storage portion
17 video/audio output portion
18 operation portion
19 audio storage portion
20 transmission/reception video storage portion

### BEST MODE FOR CARRYING OUT THE INVENTION

A television broadcast receiving device according to a best mode for carrying out the invention will be described below with reference to the drawings.

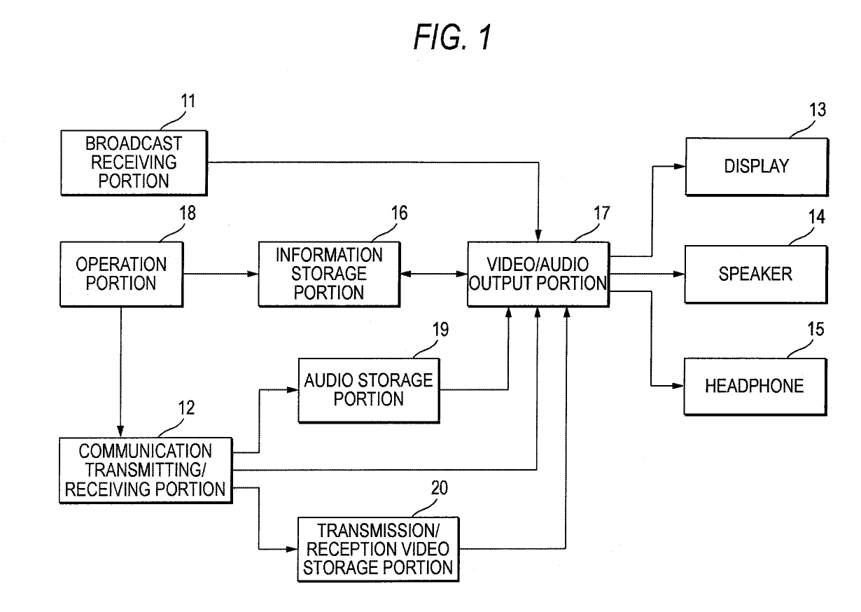

FIG. 1 is a block diagram showing the configuration of a television broadcast receiving device according to an embodiment of the invention. The television broadcast receiving device according to this embodiment is built in a mobile phone. As shown in FIG. 1, the television broadcast receiving device includes a broadcast receiving portion 11, a communication transmitting/receiving portion 12, a display 13 made of a liquid crystal display device, a speaker 14, a headphone 15, an information storage portion 16, a video/audio output portion 17, an operation portion 18, an audio storage portion 19 and a transmission/reception video storage portion 20.

The broadcast receiving portion 11 demodulates television broadcasting waves received through a television antenna (not shown) from a television broadcasting station, and outputs the demodulated television broadcast images and television broadcast sound to the video/audio output portion 17.

The communication transmitting/receiving portion 12 transmits/receives a voice (hereinafter referred to as call voice) and each character/image (hereinafter referred to as image simply) of an electronic mail etc. multiplexed by a CDMA (code-division multiple access) system etc. When the communication transmitting/receiving portion 12 receives an instruction from the operation portion 18 to temporarily store a voice of a call (hereinafter referred to as call voice) received from another terminal such as a mobile TV phone in the audio storage portion 19, the communication transmitting/receiving portion 12 stores the call voice in the audio storage portion 19 in accordance with the instruction. Further, the communication transmitting/receiving portion 12 stores each communication image transmitted/received to/from another terminal in the transmission/reception video storage portion 20. That is, the communication transmitting/receiving portion 12 serves as a call detection portion, a reception image detection portion and a transmission image detection portion.

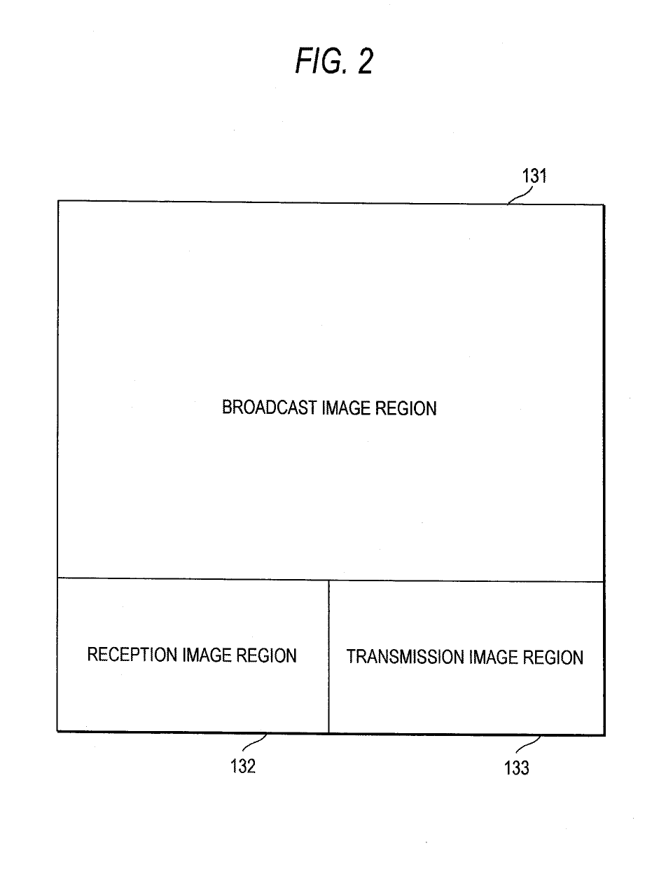

The display 13 has a broadcast image region (broadcast image display portion) 131, a reception image region (reception image display portion) 132, and a transmission image region (transmission image display portion) 133, as shown in FIG. 2. The broadcast image region 131 displays an image of a television broadcast outputted from the video/audio output portion 17. The reception image region 132 displays an image which is received from another terminal and output from the video/audio output portion 17. The transmission image region 133 displays an image which is outputted from the video/audio output portion 17 so as to be transmitted to another terminal. Incidentally, when only each television broadcast image is displayed, the whole of the screen may be used.

The speaker 14 and the headphone 15 shown in FIG. 1 output an undermentioned voice/sound outputted from the video/audio output portion 17.

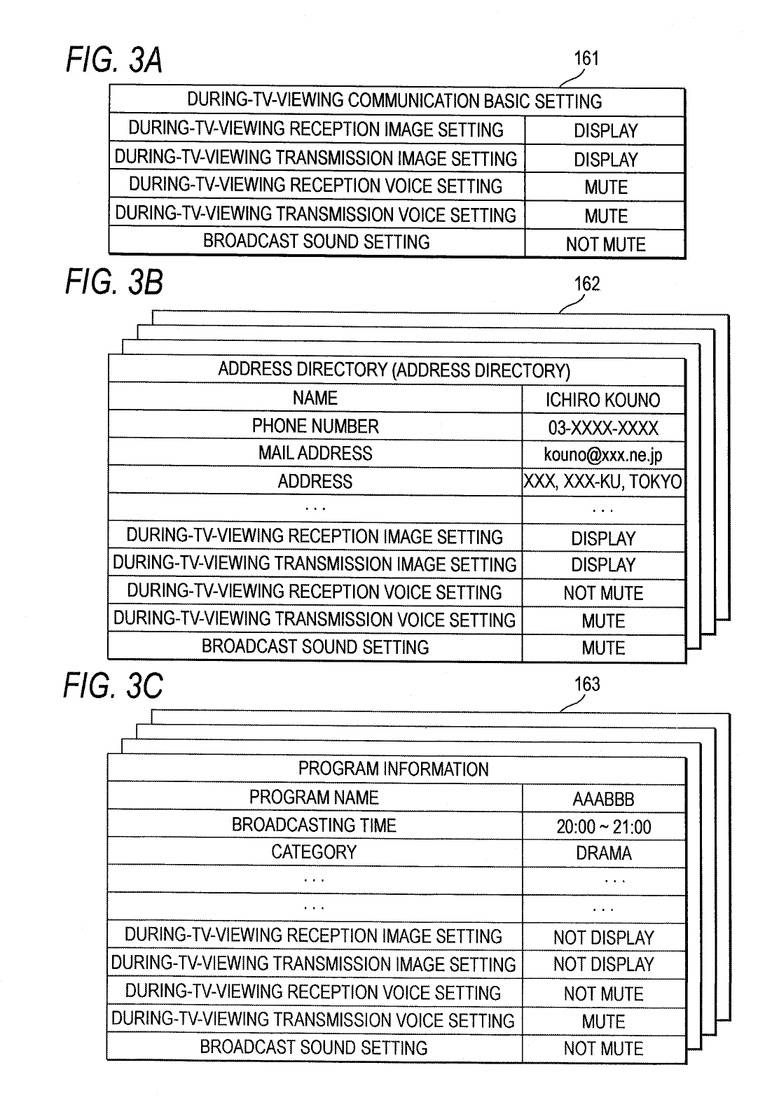

The information storage portion 16 includes a nonvolatile memory etc. The information storage portion 16 stores during-TV-viewing communication basic setting data 161, address directory data (address directory information) 162, and program information data 163 which are inputted through the operation portion 18, as shown in FIG. 3.

The during-TV-viewing communication basic setting data 161 includes (1) a during-TV-viewing reception image setting field for describing information as to whether to display the image on the reception image region 132 of the display 13 or not in the case where the image is received from another terminal during viewing of a television broadcast, (2) a during-TV-viewing transmission image setting field for describing information as to whether to display the image on the transmission image region 133 of the display 13 or not in the case where the image will be transmitted to another terminal during viewing of a television broadcast, (3) a during-TV-viewing reception voice setting field for describing information as to whether to mute a call voice on the speaker 14 or the headphone 15 or not in the case where there is a call from another terminal during viewing of a television broadcast, (4) a during-TV-viewing transmission voice setting field for describing information as to whether to mute a voice or not in the case where an image attached with the voice will be transmitted to another terminal during viewing of a television broadcast, and (5) a broadcast sound setting item for describing information as to whether to mute sound of a television broadcast on the speaker 14 or the headphone 15 or not in the case where there is a call from another terminal during viewing of the television broadcast.

The address directory data 162 includes a name field for describing a possessor's name of the other party's terminal when reception/transmission is performed, an address field for describing a processor's address, a phone number field for describing a phone number, a mail address field for describing a mail address, etc. In addition, the address directory data 162 includes a during-TV-viewing reception image setting field, a during-TV-viewing transmission image setting field, a during-TV-viewing reception voice setting field, a during-TV-viewing transmission voice setting field, a broadcast sound setting field, etc. which have equivalent contents to those described in the during-TV-viewing communication basic setting data.

The program information data 163 includes program identification information such as a program name field for describing a program name of a television broadcast, a broadcasting time field for describing a broadcasting time of the program, a category field for describing a category of the program, etc. In addition, the program information data 163 includes a during-TV-viewing reception image setting field, a during-TV-viewing transmission image setting field, a during-TV-viewing reception voice setting field, a during-TV-viewing transmission voice setting field, a broadcast sound setting field, etc. which have equivalent contents to those described in the during-TV-viewing communication basic setting data.

The during-TV-viewing reception voice setting field, the during-TV-viewing transmission voice setting field, and the broadcast sound setting field serve as a voice/sound specifying information storage portion. The during-TV-viewing reception image setting field serves as a reception image display permission information storage portion. The during-TV-viewing transmission image setting field serves as a transmission image display permission information storage portion.

When a call from another terminal during televising of a television broadcast is detected by the communication transmitting/receiving portion 12, the video/audio output portion 17 shown in FIG. 1 uses information of any one of the during-TV-viewing communication basic setting data 161, the address directory data 162 and the program information data 163 stored in the information storage portion 16, and outputs, to the speaker 14 or the headphone 15, any one of television broadcast sound superimposed on the call voice, the television broadcast sound remaining after the call voice is muted, and the call voice remaining after the television broadcast sound is muted.

When an image received from another terminal during televising of a television broadcast is detected by the communication transmitting/receiving portion 12, the video/audio output portion 17 uses information of any one of the during-TV-viewing communication basic setting data 161, the address directory data 162 and the program information data 163, and outputs the image to the display 13 in the case where the image has to be displayed on the display 13.

When an image which will be transmitted to another terminal during televising of a television broadcast is detected by the communication transmitting/receiving portion 12, the video/audio output portion 17 uses information of any one of the during-TV-viewing communication basic setting data 161, the address directory data 162 and the program information data 163, and outputs the image to the display 13 in the case where the image has to be displayed on the display.

When, for example, selection setting data are set in the during-TV-viewing communication basic setting data 161 so that “display” is described in the during-TV-viewing reception image setting field, “display” is described in the during-TV-viewing transmission image setting field, “mute” is described in the during-TV-viewing reception voice setting field, and “not mute” is described in the broadcast sound setting field in the during-TV-viewing communication basic data 161 as shown in FIG. 3(a), the video/audio output portion 17 selects display of images and outputs of voice/sound as follows.

a) The Case where there is a Call from Another Call During Viewing of a Television Broadcast:

While displaying images of the television broadcast on the broadcast image region 131 in the display 13, the video/audio output portion 17 mutes (deadens) a call voice so as to output only sound of the television broadcast which is being viewed, to the speaker 14 or the headphone 15. Since there is no image received or transmitted in this case, no image is displayed on the reception image region 132 and the transmission image region 133 in the display 13.

b) The Case where Only Images are Received from Another Terminal During Viewing of a Television Broadcast:

While outputting images of the television broadcast to the broadcast image region 131 in the display 13, the video/audio output portion 17 outputs the received images to the reception image region 132 in the display 13. In addition, the video/audio output portion 17 outputs sound of the television broadcast to the speaker 14 or the headphone 15.

c) The Case where Images Attached with a Voice are Received from Another Terminal During Viewing of a Television Broadcast:

While outputting images of the television broadcast to the broadcast image region 131 in the display 13, the video/audio output portion 17 outputs the received images to the reception image region 132 in the display 13. In addition, the video/audio output portion 17 mutes (deadens) the call voice so as to output only sound of the television broadcast which is being viewed, to the speaker 14 or the headphone 15. Since there is no image to be transmitted in this case, no image is displayed on the transmission image region 133 in the display 13.

d) The Case where Only Images will be Transmitted to Another Terminal During Viewing of a Television Broadcast:

While outputting images of the television broadcast to the broadcast image region 131 in the display 13, the video/audio output portion 17 outputs the images to be transmitted, to the transmission image region 133 in the display 13. In addition, the video/audio output portion 17 outputs sound of the television broadcast to the speaker 14 or the headphone 15. Since there is no image received from any other terminal in this case, no image is displayed on the reception image region 132 in the display 13.

e) The Case where Images Attached with a Voice will be Transmitted to Another Terminal During Viewing of a Television Broadcast:

While outputting images of the television broadcast to the broadcast image region 131 in the display 13, the video/audio output portion 17 displays the images to be transmitted, on the transmission image region 133 in the display 13. In addition, the video/audio output portion 17 mutes (deadens) the call voice so as to output only a broadcast sound of the television broadcast which is being viewed, to the speaker 14 or the headphone 15. Since there is no image received from any other terminal in this case, no image is displayed on the reception image region 132 in the display 13.

The operation portion 18 is provided with operation keys such as ten-keys, character keys, a power key etc. The operation portion 18 is constituted by a remote controller for outputting input information by use of infrared rays, various keys attached to the television broadcast receiving device, etc. The mode of the operation portion 18 is not limited particularly as long as the operation portion 18 can perform input operation. The operation portion inputs the during-TV-viewing communication basic setting data 161, the address directory data 162 and the program information data 163 to the information storage portion 16. The operation portion 18 outputs an instruction to the communication transmitting/receiving portion 12 to store a call voice transmitted from another terminal in the audio storage portion 19 in order to listen to the call voice from the speaker 14 or the headphone 15 after the end of a television broadcast.

The audio storage portion 19 stores the call voice transmitted from the other terminal in order to listen to the call voice from the speaker 14 or the headphone 15 after the end of the television broadcast. The transmission/reception video storage portion 20 stores images transmitted/received to/from another terminal.

Next, operation of the television broadcast receiving device according to the embodiment will be described.

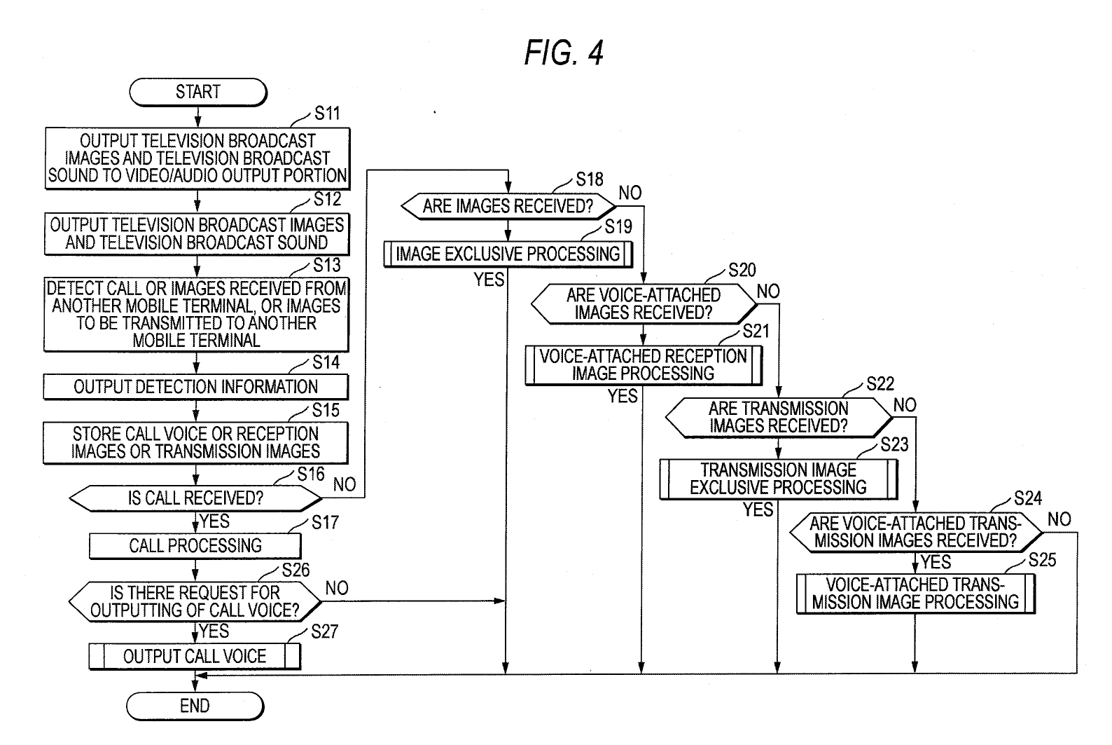

FIG. 4 is a flow chart showing the operation of the television broadcast receiving device according to the embodiment.

When power (not shown) is turned on, the broadcast receiving portion 11 demodulates waves of a television broadcast received from a television broadcasting station, and outputs the demodulated television broadcast images and television broadcast sound to the video/audio output portion 17 (step S11). While outputting the images of the television broadcast to the display 13, the video/audio output portion 17 outputs the sound to the speaker 14 or the headphone 15 (step S12).

When the communication transmitting/receiving portion 12 detects a call or images received from another terminal, or images to be transmitted to another terminal during televising of the images and sound of the television broadcast (step S13), the communication transmitting/receiving portion 12 outputs the detection information to the video/audio output portion 17 (step S14), and then outputs the voice to the image/audio storage portion 19 in the case of the call, and the images to the transmission/reception video storage portion 20 in the case of the images (step S15).

The detection information transmitted to the video/audio output portion 17 is a) a message and a phone number of another terminal when a call is received from the other terminal, b) a message and a mail address of another terminal having transmitted images when only the images are received from the other terminal, c) a massage and a mail address of another terminal having transmitted communication images when the images attached with a voice are received from the other terminal, d) a message and a mail address of another terminal as a transmission destination when only images will be transmitted to the other terminal, or e) a message and a mail address of another terminal as a transmission destination when images attached with a voice will be transmitted to the other terminal.

When the detection information is inputted from the communication transmitting/receiving portion 12, the video/audio output portion 17 judges whether a call is received from another terminal or not (step S16). When deciding that the call is received (YES in the step S16), the video/audio output portion 17 executes call processing as will be described later, and proceeds to step S26. When deciding that the call is not received (NO in the step S16), the video/audio output portion 17 judges whether only images are received from another terminal or not (step S18). When deciding that only the images are received (YES in the step S18), the video/audio output portion 17 executes reception image exclusive processing as will be described later (step S19), and terminates the process. When deciding that the images are not received (NO in the step S18), the video/audio output portion 17 judges whether images attached with a voice are received from another terminal or not (step S20). When deciding that the images attached with a voice are received (YES in the step S20), the image/voice input portion 17 executes voice-attached reception image processing as will be described later (step S21), and terminates the process. When deciding that the images with a voice are not received (NO in the step S20), the video/audio output portion 17 judges whether only images will be transmitted to another terminal or not (step S22). When the video/audio output portion 17 decides that only the images will be transmitted (YES in the step S22), the video/audio output portion 17 executes transmission image exclusive processing as will be described later (step S23), and terminates the process. When deciding that the images will not be transmitted (NO in the step S22), the video/audio output portion 17 judges whether images attached with a voice will be transmitted to another terminal or not (step S24). When deciding that the images attached with a voice will be transmitted (YES in the step 24), the video/audio output portion 17 executes voice-attached transmission image processing as will be described later (step S25), and terminates the process. When deciding that the images attached with a voice will not be transmitted (NO in the step S24), the video/audio output portion 17 terminates the process.

Then, the video/audio output portion 17 judges whether or not there is a request from the communication transmitting/receiving portion 12 for outputting of the received call voice to the speaker 14 or the headphone 15 (step S26). When deciding that there is a request (YES in the step S26), the video/audio output portion 17 reads a voice stored in the audio storage portion 19 and outputs the voice to the speaker 14 or the headphone 15 (step S27). On the other hand, when deciding that there is no request (NO in the step S26), the video/audio output portion 17 terminates the process.

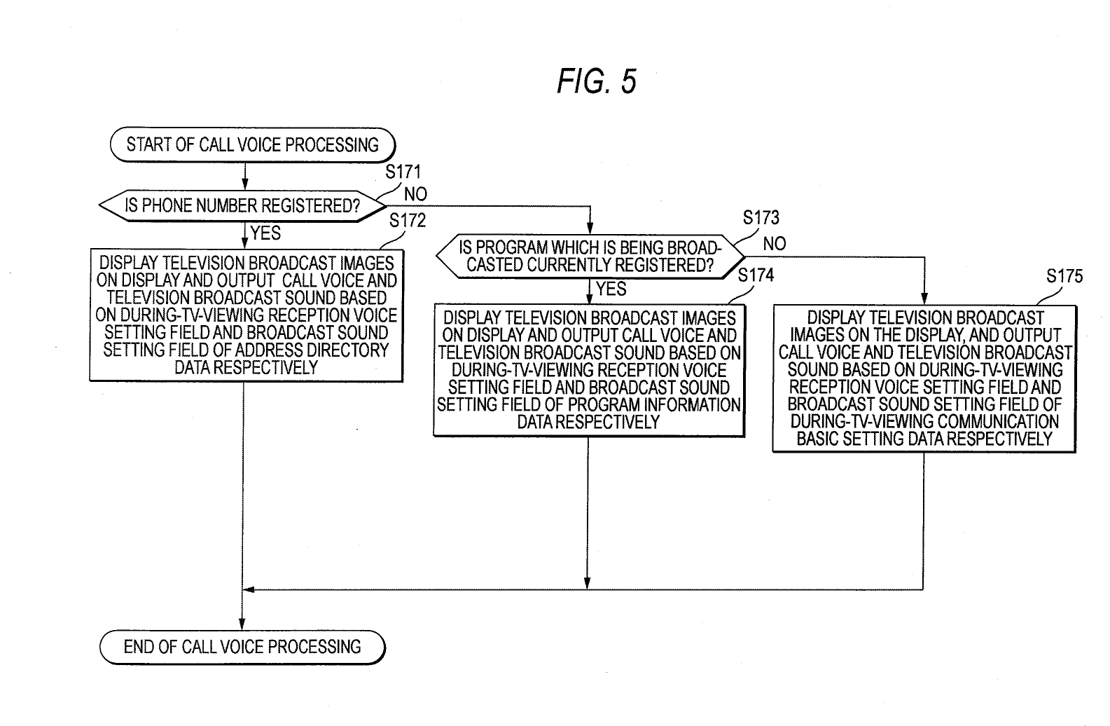

Next, details of the call processing in the step S17 will be described with reference to FIG. 5.

When deciding that the call is received from the other terminal during viewing of the television broadcast (YES in the step S16), the video/audio output portion 17 judges whether or not a phone number of a calling party is registered in the phone number field of the address directory data 162 stored in the information storage portion 16 (step S171). When deciding that the phone number of the calling party is registered (YES in the step 171), the video/audio output portion 17 not only displays the broadcast images on the broadcast image region 131 of the display 13 but also displays the call voice and the television broadcast sound to the speaker 14 and the headphone 15 based on the during-TV-viewing reception voice setting field and the broadcast sound setting field of the address directory data 162 respectively (step S172).

In the case where the during-TV-viewing reception voice setting field is set to be “not mute” and the broadcast sound setting field is set to be “mute” in the address directory data 162 as shown in FIG. 3(b), the video/audio output portion 17 displays the broadcast images on the display 13, and mutes a speech voice of the television broadcast so as to output only the call voice to the speaker 14 or the headphone 15. The speaker 14 or the headphone 15 outputs only the call voice.

When deciding in the step S171 that the phone number of the calling party is not registered in the phone number field of the address directory data 162 (NO in the step S171), the video/audio output portion 17 judges whether the program which is being broadcasted currently is registered in the program information 163 stored in the information storage portion 16 or not (step S173). When deciding that the program which is being broadcasted currently is registered in the program information data 163 stored in the information storage portion 16 (YES in the step S173), the video/audio output portion 17 not only displays the broadcast images on the display 13 but also outputs the call voice and the sound of the television broadcast to the speaker 14 and the headphone 15 based on the during-TV-viewing reception voice setting field and the communication broadcast sound setting field of the program information data 163 respectively (step S174).

In the case where the during-TV-viewing reception voice setting field is set to be “not mute” and the broadcast sound setting field is set to be “not mute” in the program information data 163 as shown in FIG. 3(c), the video/audio output portion 17 not only displays the broadcast images on the display 13 but also outputs mixture audio of the call voice and the broadcast sound to the speaker 14 or the headphone 15. The speaker 14 or the headphone 15 outputs the mixture audio of the call voice and the broadcast sound.

When deciding in the step S173 that the program which is being broadcasted currently is not registered in the program information data 163 stored in the information storage portion 16 (NO in the step S173), the video/audio output portion 17 not only displays the broadcast images on the broadcast image region 131 of the display 13, but also outputs the television broadcast sound and the call voice to the speaker 14 and the headphone 15 based on the during-TV-viewing reception voice setting field and the communication broadcast sound setting field of the during-TV-viewing communication basic setting data 161 respectively (step S175).

When the during-TV-viewing reception voice setting field is set to be “mute” and the broadcast sound setting field is set to be “not mute” in the during-TV-viewing communication basic setting data 161 as shown in FIG. 3(a), the video/audio output portion 17 not only displays the broadcast images on the display 13 but also mutes the call voice so as to output only the television broadcast sound to the speaker 14 or the headphone 15. The speaker 14 or the headphone 15 outputs only the television broadcast sound.

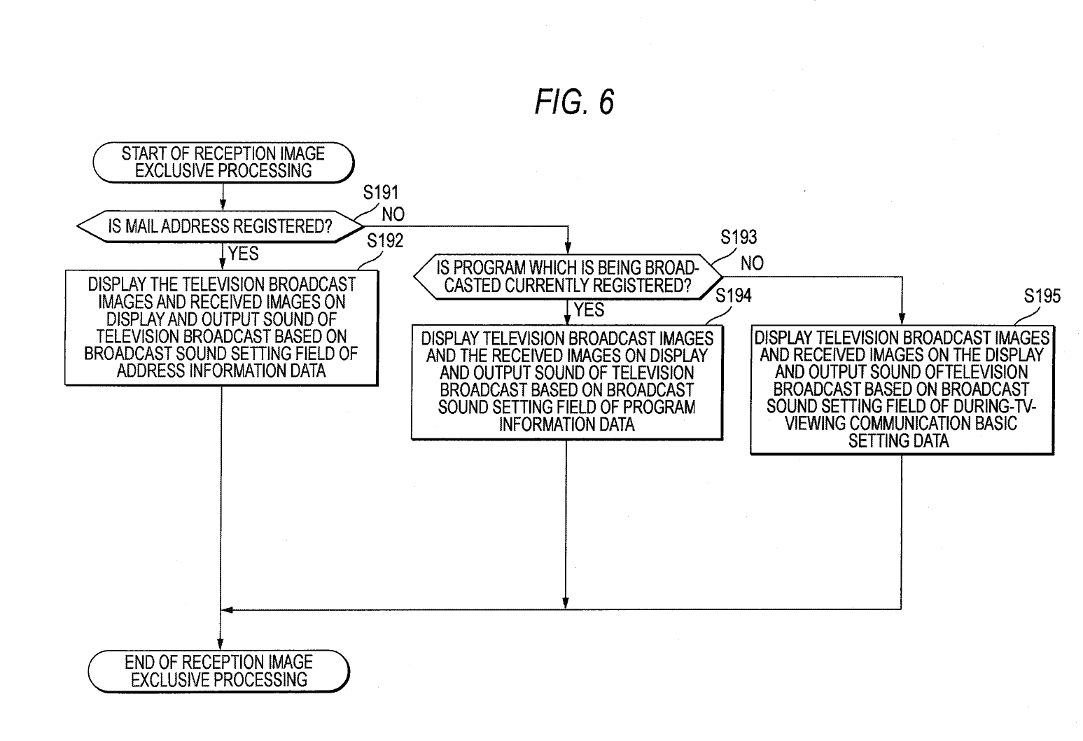

Details of the image exclusive processing in the step 19 of FIG. 4 will be described with reference to FIG. 6.

In the reception image exclusive processing in the step S19, when deciding that only the images are received from the other terminal during viewing of the television broadcast (YES in the step S18), the video/audio output portion 17 judges whether a mail address of a communication party is registered in the mail address field of the address directory data 162 stored in the information storage portion 16 or not (step S191). When deciding that the mail address of the communication party is registered (YES in the step S191), the video/audio output portion 17 displays not only the broadcast images of the television broadcast on the broadcast image region 131, but also the received communication images on the reception image region 132 of the display 13 based on the during-TV-viewing reception image setting of the address directory data 162, and the video/audio output portion 17 outputs the sound of the television broadcast to the speaker 14 and the headphone 15 based on the broadcast sound setting field (step S192).

In the case where the during-TV-viewing reception image setting field is set to be “display” and the broadcast sound setting field is set to be “mute” in the address directory data 162 as shown in FIG. 3(b), the video/audio output portion 17 not only displays the broadcast images of the television broadcast on the broadcast image region 131 of the display 13 but also displays the received communication images on the reception image region 132. In addition, the image/voice outputs portion 17 mutes the broadcast sound so as not to input the voice to the speaker 14 or the headphone 15.

When deciding in the step S191 that the mail address of the communication party is not registered in the mail address field of the address directory data 162 (NO in the step S191), the video/audio output portion 17 judges whether the program which is being broadcasted currently is registered in the program information data 163 stored in the information storage portion 16 or not (step S193). When deciding that the program which is being broadcasted currently is registered in the program information data 163 stored in the information storage portion 16 (YES in the step S193), the video/audio output portion 17 not only displays the broadcast images of the television broadcast on the broadcast image region 131 of the display 13 but also displays the received communication images on the reception image region 132 based on the during-TV-viewing reception image setting field of the program information data 163, and the video/audio output portion 17 outputs the broadcast sound of the television broadcast to the speaker 14 or the headphone 15 based on the broadcast sound setting field as a field of the program information data (step S194).

In the case where the during-TV-viewing reception image setting is set to be “not display” and the broadcast sound setting field is set to be “not mute” in the program information data 163 as shown in FIG. 3(c), the video/audio output portion 17 does not display the received communication images on the display 132 but displays only the broadcast images of the television broadcast on the broadcast image region 131 of the display 13. In addition, the video/audio output portion 17 outputs the broadcast sound to the speaker 14 or the headphone 15. The speaker 14 or the headphone 15 outputs the broadcast sound.

When deciding in the step S193 that the program which is being broadcasted currently is not registered in the program information data 163 stored in the information storage portion 16 (NO in the step S193), the video/audio output portion 17 not only displays the television broadcast images on the broadcast image region 131 of the display 13 but also displays the received communication images on the reception image region 132 of the display 13 based on the during-TV-viewing reception image setting field of the during-TV-viewing communication basic setting data 161, and the video/audio output portion 17 outputs the sound of the television broadcast to the speaker 14 and the headphone 15 based on the broadcast sound setting field (step S195).

When the during-TV-viewing reception image setting field is set to be “display” and the broadcast sound setting field is set to be “not mute” in the during-TV-viewing communication basic setting data 161 as shown in FIG. 3(a), the video/audio output portion 17 not only displays the broadcast images of the television broadcast on the broadcast image region 131 of the display 13 but also displays the received communication images on the reception image region 132. In addition, the video/audio output portion 17 outputs the broadcast sound of the television broadcast to the speaker 14 or the headphone 15. The speaker 14 or the headphone 15 outputs only the sound of the television broadcast.

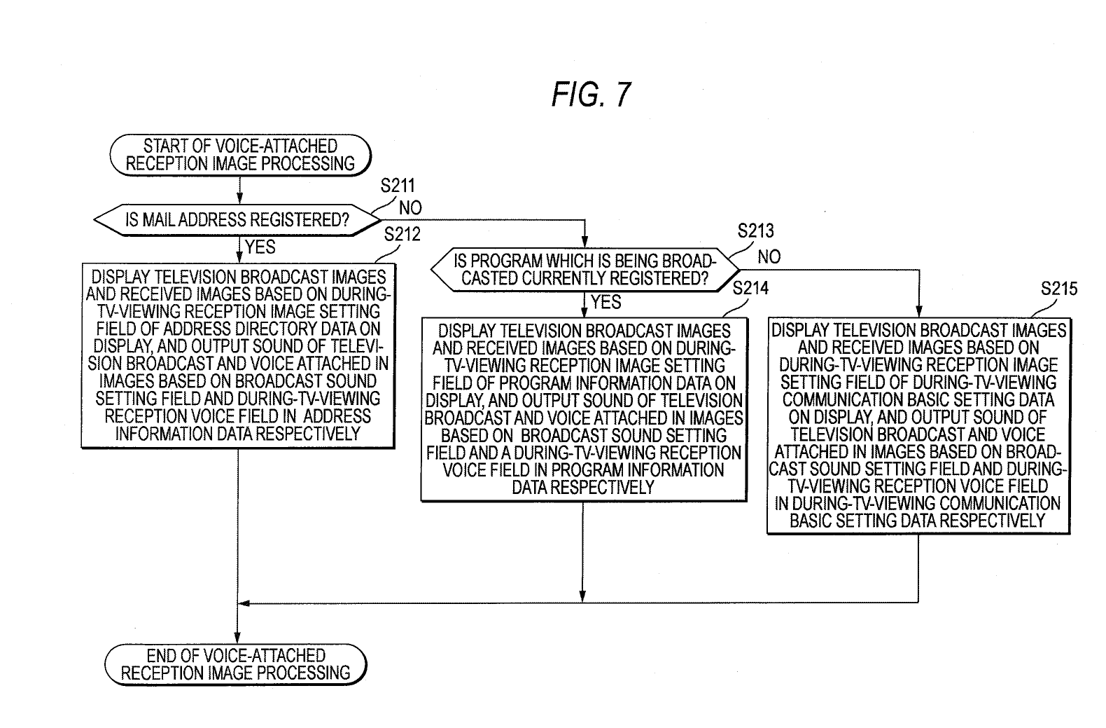

Next, details of the voice-attached reception image processing in the step S21 of FIG. 4 will be described with reference to FIG. 7.

In the voice-attached reception image processing in the step S21, when deciding that the voice-attached images are received from the other terminal during viewing of the television broadcast (YES in the step S20), the video/audio output portion 17 judges whether a mail address of the other party is registered in the mail address field of the address directory data 162 stored in the information storage portion 16 or not (step S211). When deciding that the mail address of the other party is registered (YES in the step S211), the video/audio output portion 17 not only displays the received images on the reception image region 132 of the display 13 based on the during-TV-viewing reception image setting of the address directory data 162, but also displays the television broadcast images on the broadcast image region 131, and the video/audio output portion 17 outputs the broadcast sound of the television broadcast and the received call voice to the speaker 14 and the headphone 15 based on the broadcast sound setting field and the during-TV-viewing reception voice setting field respectively (step S212).

In the case where the during-TV-viewing reception image setting field is set to be “display”, the during-TV-viewing reception voice setting field is set to be “not mute” and the broadcast sound setting field is set to be “mute” in the address directory data 162 as shown in FIG. 3(b), not only are the broadcast images of the television broadcast displayed on the broadcast image region 131 of the display 13 but also the received communication images are displayed on the reception image region 132, and the broadcast sound is muted so that only the received communication voice is output to the speaker 14 or the headphone 15.

When deciding in the step S211 that the mail address of the communication party is not registered in the mail address field of the address directory data 162 stored in the information storage portion 16 (NO in the step S211), the video/audio output portion 17 judges whether the program which is being broadcasted currently is registered in the program information data 163 stored in the information storage portion 16 or not (step S213). When deciding that the program which is being broadcasted currently is registered in the program information data 163 stored in the information storage portion 16 (YES in the step S213), the video/audio output portion 17 not only displays the broadcast images of the television broadcast on the broadcast image region 131 of the display 13 but also displays the received communication images on the reception image region 132 based on the during-TV-viewing reception image setting field, and the video/audio output portion 17 outputs the broadcast sound of the television broadcast and the received communication voice to the speaker 14 and the headphone 15 based on the broadcast sound setting field and the during-TV-viewing reception voice setting field of the program information data 163 respectively (step S214).

In the case where the during-TV-viewing reception image setting is set to be “not display”, the during-TV-viewing reception voice setting field is set to be “not mute” and the broadcast sound setting field is set to be “not mute” in the program information data 163 as shown in FIG. 3(c), the video/audio output portion 17 does not display the received communication images on the reception image region 132 but displays the broadcast images of the television broadcast on the broadcast image region of the display 13. In addition, the video/audio output portion 17 outputs mixture audio of the broadcast sound of the television broadcast and the received communication voice to the speaker 14 or the headphone 15. The speaker 14 or the headphone 15 outputs the mixture audio of the broadcast sound and the received communication voice.

When deciding in the step S213 that the program which is being broadcasted currently is not registered in the program information data 163 stored in the information storage portion 16 (NO in the step S213), the video/audio output portion 17 not only displays the broadcast images of the television broadcast on the broadcast image region 131 of the display 13 but also displays the received communication images on the reception image region 132 of the display 13 based on the during-TV-viewing reception image setting field of the during-TV-viewing communication basic setting data 161, and the video/audio output portion 17 outputs the received communication voice and the broadcast sound of the television broadcast to the speaker 14 and the headphone 15 based on the during-TV-viewing reception voice setting field and the broadcast sound setting field of the during-TV-viewing communication basic setting data 161 respectively (step S215).

When the during-TV-viewing reception image setting field is set to be “display”, the during-TV-viewing reception voice setting field is set to be “mute”, and the broadcast sound setting field is set to be “not mute” in the during-TV-viewing communication basic setting data 161 as shown in FIG. 3(a), the video/audio output portion 17 not only displays the broadcast images of the television broadcast on the broadcast image region 131 of the display 13 but also displays the received communication images on the reception image region 132. In addition, the video/audio output portion 17 mutes the received communication voice so as to output only the broadcast sound of the television broadcast to the speaker 14 or the headphone 15. The speaker 14 or the headphone 15 outputs the broadcast sound.

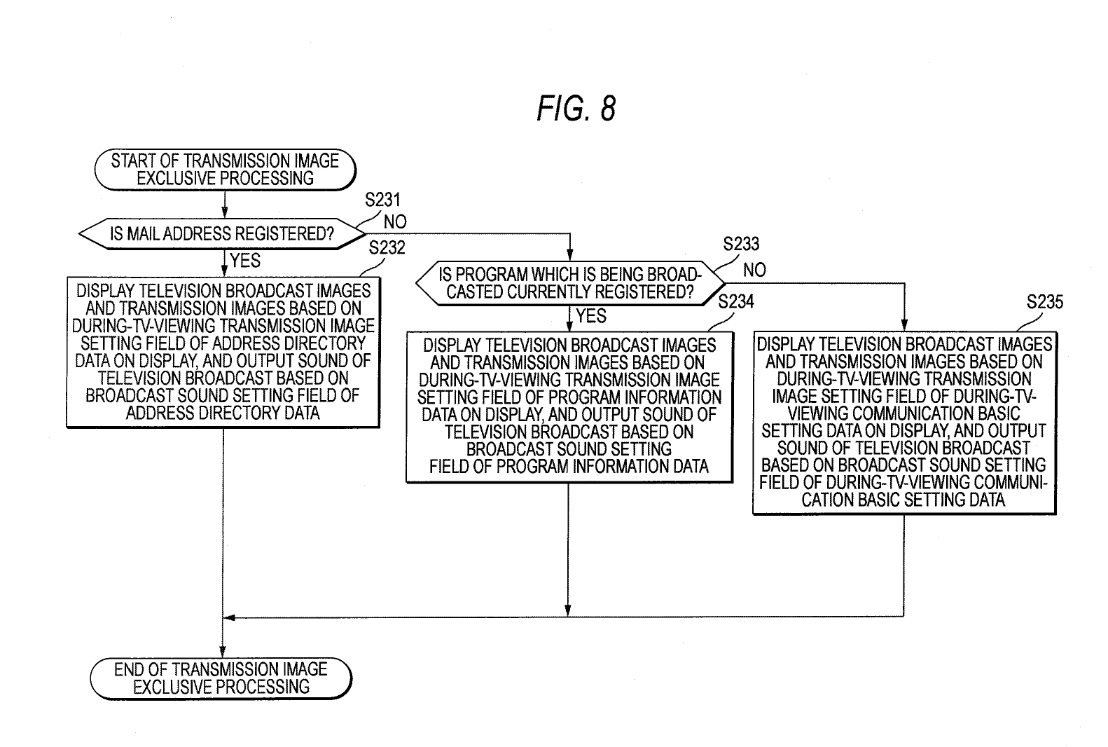

Details of the transmission image processing in the step 23 of FIG. 4 will be described with reference to FIG. 8.

In the transmission image exclusive processing in the step S23, when deciding that only the images will be transmitted to the other terminal during viewing of the television broadcast (YES in the step S22), the video/audio output portion 17 judges whether a mail address of the terminal as a transmission designation is registered in the mail address field of the address directory data 162 stored in the information storage portion 16 or not (step S231). When deciding that the mail address of the terminal as a transmission destination is registered (YES in the step S231), the video/audio output portion 17 not only displays the broadcast images of the television broadcast on the broadcast image region 131, but also displays the communication images to be transmitted, on the transmission image region 133 of the display 13 based on the during-TV-viewing transmission image setting field of the address directory data 162, and the video/audio output portion 17 outputs the sound of the television broadcast to the speaker 14 and the headphone 15 based on the broadcast sound setting field (step S232).

In the case where the during-TV-viewing transmission image setting field is set to be “display” and the broadcast sound setting field is set to be “mute” in the address directory data 162 as shown in FIG. 3(b), the video/audio output portion 17 not only displays the broadcast images of the television broadcast on the broadcast image region 131 of the display 13 but also displays the communication images to be transmitted on the transmission image region 133. In addition, the image/audio output portion 17 mutes the broadcast sound so as not to output the sound to the speaker 14 or the headphone 15.

When deciding in the step S231 that the mail address of the terminal as a transmission designation is not registered in the mail address field of the address directory data 162 (NO in the step S231), the video/audio output portion 17 judges whether the program which is being broadcasted currently is registered in the program information data 163 stored in the information storage portion 16 or not (step S233). When deciding that the program which is being broadcasted currently is registered in the program information data 163 stored in the information storage portion 16 (YES in the step S233), the video/audio output portion 17 not only displays the broadcast images of the television broadcast on the broadcast image region 131 of the display 13 but also displays the communication images to be transmitted on the transmission image region 133 based on the during-TV-viewing transmission image setting field of the program information data 163, and the video/audio output portion 17 outputs the broadcast sound of the television broadcast to the speaker 14 or the headphone 15 based on the broadcast sound setting field as a field of the program information data (step S234).

In the case where the during-TV-viewing transmission image setting is set to be “not display” and the broadcast sound setting field is set to be “not mute” in the program information data 163 as shown in FIG. 3(c), the video/audio output portion 17 does not display the communication images to be transmitted on the display 13 but displays only the broadcast images of the television broadcast on the broadcast image region 131 of the display 13. In addition, the video/audio output portion 17 outputs the broadcast sound to the speaker 14 or the headphone 15. The speaker 14 or the headphone 15 outputs the broadcast sound.

When deciding in the step S233 that the program which is being broadcasted currently is not registered in the program information data 163 stored in the information storage portion 16 (NO in the step S233), the video/audio output portion 17 not only displays the broadcast images of the television broadcast on the broadcast image region 131 of the display 13 but also displays the communication images to be transmitted on the transmission image region 132 of the display 13 based on the during-TV-viewing transmission image setting field of the during-TV-viewing communication basic setting data 161, and the video/audio output portion 17 outputs the sound of the television broadcast to the speaker 14 and the headphone 15 based on the broadcast sound setting field (step S235).

When the during-TV-viewing transmission image setting field is set to be “display” and the broadcast sound setting field is set to be “not mute” in the during-TV-viewing communication basic setting data 161 as shown in FIG. 3(a), the video/audio output portion 17 not only displays the broadcast images of the television broadcast on the broadcast image region 131 of the display 13 but also displays the communication images to be transmitted on the transmission image region 133. In addition, the video/audio output portion 17 outputs the broadcast sound of the television broadcast to the speaker 14 or the headphone 15. The speaker 14 or the headphone 15 outputs only the sound of the television broadcast.

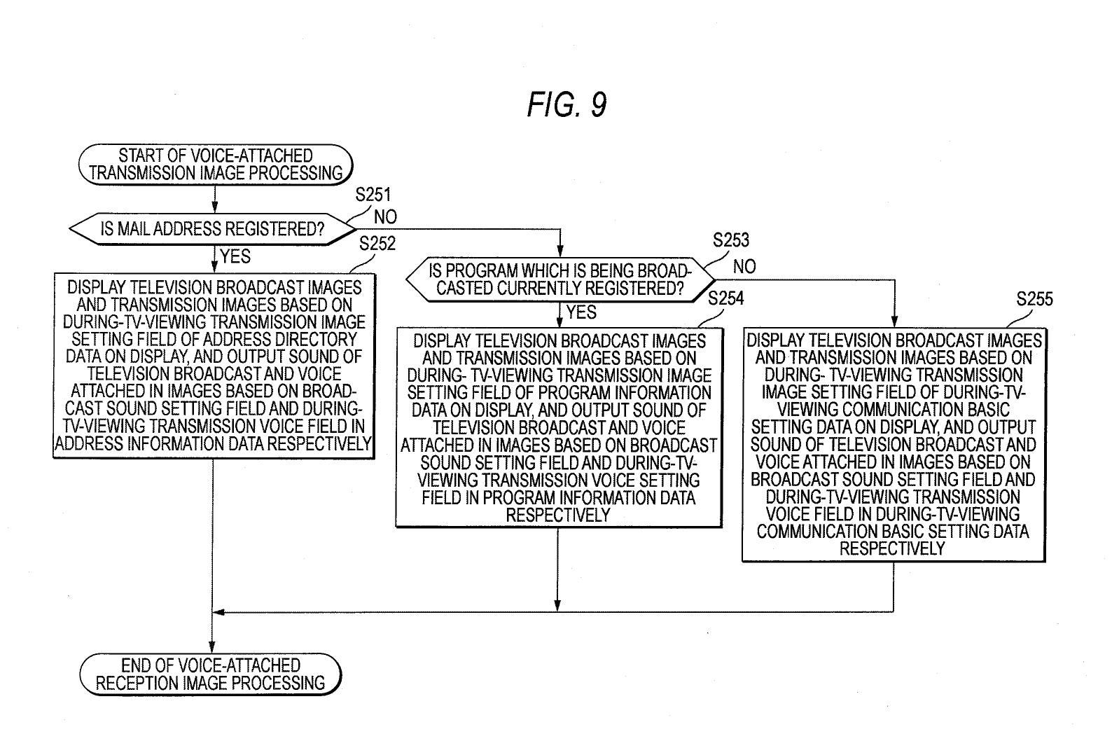

Details of the voice-attached transmission image processing in the step 25 of FIG. 4 will be described with reference to FIG. 9.

In the voice-attached transmission image processing in the step S25, when deciding that the voice-attached images will be transmitted to the other terminal during viewing of the television broadcast (YES in the step S24), the video/audio output portion 17 judges whether a mail address of the terminal as a transmission destination is registered in the mail address field of the address directory data 162 stored in the information storage portion 16 or not (step S251). When deciding that the mail address of the terminal as a transmission destination is registered (YES in the step S251), the video/audio output portion 17 not only displays the transmission images on the transmission image region 133 of the display 13 based on the during-TV-viewing transmission image setting field of the address directory data 162 but also displays the broadcast images of the television broadcast on the broadcast image region 131, and the video/audio output portion 17 outputs the broadcast sound of the television broadcast and a communication voice to be transmitted, to the speaker 14 and the headphone 15 based on the broadcast sound setting field and the during-TV-viewing transmission voice setting field respectively (step S252).

In the case where the during-TV-viewing transmission image setting field is set to be “display”, the during-TV-viewing transmission voice setting field is set to be “mute”, and the broadcast sound setting field is set to be “mute” in the address directory data 162 as shown in FIG. 3(b), not only are the broadcast images of the television broadcast displayed on the broadcast image region 131 of the display 13 but also the communication images to be transmitted are displayed on the transmission image region 132. In addition, the broadcast sound is muted and the voice included in the communication images to be transmitted is muted so that the sound/voice is not outputted to the speaker 14 or the headphone 15.

When deciding in the step S251 that the mail address of the terminal as a transmission destination is not registered in the mail address field of the address directory data 162 stored in the information storage portion 16 (NO in the step S251), the video/audio output portion 17 judges whether the program which is being broadcasted currently is registered in the program information data 163 stored in the information storage portion 16 or not (step S253). When deciding that the program which is being broadcasted currently is registered in the program information data 163 stored in the information storage portion 16 (YES in the step S253), the video/audio output portion 17 not only displays the broadcast images of the television broadcast on the broadcast image region 131 of the display 13 but also displays the communication images to be transmitted on the transmission image region 133 based on the during-TV-viewing transmission image setting field, and the video/audio output portion 17 outputs the voice included in the transmission images and the broadcast sound of the television broadcast to the speaker 14 and the headphone 15 based on the during-TV-viewing transmission voice setting field and the broadcast sound setting field in the program information data 163, respectively (step S254).

In the case where the during-TV-viewing transmission image setting is set to be “not display”, the during-TV-viewing transmission voice setting field is set to be “mute”, and the broadcast sound setting field is set to be “not mute” in the program information data 163 as shown in FIG. 3(c), the video/audio output portion 17 does not display the transmitted communication images on the reception image region 133 but displays the broadcast images of the television broadcast on the broadcast image region 131 of the display 13. In addition, the video/audio output portion 17 mutes the voice included in the images to be transmitted, so as to output only the broadcast sound of the television broadcast to the speaker 14 or the headphone 15.

When deciding in the step S253 that the program which is being broadcasted currently is not registered in the program information data 163 stored in the information storage portion 16 (NO in the step S253), the video/audio output portion 17 not only displays the broadcast images of the television broadcast on the broadcast image region 131 of the display 13 but also displays the received communication images on the reception image region 132 of the display 13 based on the during-TV-viewing reception image setting field of the during-TV-viewing communication basic setting data 161, and the video/audio output portion 17 outputs the received communication voice and the broadcast sound of the television broadcast to the speaker 14 and the headphone 15 based on the during-TV-viewing reception voice setting field and the broadcast sound setting field in the during-TV-viewing communication basic setting data 161, respectively (step S255).

When the during-TV-viewing transmission image setting field is set to be “display”, the during-TV-viewing transmission voice setting field is set to be “mute” and the broadcast sound setting field is set to be “not mute” in the during-TV-viewing communication basic setting data 161 as shown in FIG. 3(a), the video/audio output portion 17 not only displays the broadcast images of the television broadcast on the broadcast image region 131 of the display 13 but also displays the communication images to be transmitted on the transmission image region 133. In addition, the video/audio output portion 17 mutes the voice included in the images to be transmitted, so as to output only the broadcast sound of the television broadcast to the speaker 14 or the headphone 15. The speaker 14 or the headphone 15 outputs the broadcast sound.

According to the television broadcast receiving device in this embodiment, during-TV-viewing reception voice setting information is stored in the information storage portion 16 so that the video/audio output portion 17 can selectively output broadcast sound of a television broadcast superimposed on a call voice of a call transmitted from another terminal, or a voice/sound remaining after one of the broadcast sound and the call voice is muted, when broadcast images of the television broadcast are displayed. Thus, even when there is an incoming call during viewing of a broadcast program having high real-time information such as news, sports, etc., the call can be answered without interrupting the program.

In addition, according to the television broadcast receiving device in this embodiment, even in the case where a voice of a call is muted so that only a broadcast sound of a television broadcast is outputted, the muted call voice can be stored in the audio storage portion 19 so that an important matter from another terminal can be confirmed after the end of the program.

In addition, in the television broadcast receiving device according to this embodiment, phone numbers of terminals and during-TV-viewing reception voice setting information are described in address directory data stored in the information storage portion 16 so that the video/audio output portion 17 can select an output mode of a call voice in accordance with each of the phone numbers of the calling/called terminals, to thereby mute or not mute the call voice in accordance with importance degree of the calling/called party.

In addition, in the television broadcast receiving device according to this embodiment, programs of television broadcasts and during-TV-viewing reception voice setting information are stored in program information data stored in the information storage portion 16, so that the video/audio output portion 17 can select an output mode of a call voice based on each of the programs of the television broadcasts, to thereby mute or not mute the call voice in accordance with importance degree of the calling/called party.

In addition, in the television broadcast receiving device according to this embodiment, during-TV-viewing reception image setting information is stored in the information storage portion 16, so that the video/audio output portion 17 can select a display mode of received images based on the during-TV-viewing image setting information, to thereby display or not display the images in accordance with importance degree of the received images.

In addition, in the television broadcast receiving device according to this embodiment, each mail address of each terminal having sent reception images and during-TV-viewing reception image setting information are described in the address directory data stored in the information storage portion 16, so that the video/audio output portion 17 can select a display mode of the received images, to thereby display or not display the images in accordance with importance degree of the received images.

In addition, in the television broadcast receiving device according to this embodiment, each program of each television broadcast and during-TV-viewing reception image setting information are described in the program information data stored in the information storage portion 16, so that the video/audio output portion 17 can select a display mode of received images, to thereby display or not display the images in accordance with importance degree of the received images.

In addition, in the television broadcast receiving device according to this embodiment, during-TV-viewing transmission image setting information is stored in the information storage portion 16, so that the video/audio output portion 17 can select a display mode of transmission images to another terminal, based on the during-TV-viewing transmission image setting information, to thereby display or not display the images in accordance with importance degree of the transmission images.

In addition, in the television broadcast receiving device according to this embodiment, each mail address of each terminal to which images will be transmitted and during-TV-viewing transmission image setting information are described in the address directory data stored in the information storage portion 16, so that the video/audio output portion 17 can select a display mode of the transmission images, to thereby display or not display the images in accordance with importance degree of the transmission images.

In addition, in the television broadcast receiving device according to this embodiment, each program of each television broadcast and during-TV-viewing transmission image setting information are described in the program information data stored in the information storage portion 16, so that the video/audio output portion 17 can select a display mode of transmission images, to thereby display or not display the images in accordance with importance degree of the transmission images.

Although the television broadcast receiving device according to the invention is incorporated in a mobile phone so as to be used as a mobile TV terminal, particularly a mobile TV phone, applied products are not limited particularly. A receiving device, a phone function, and a mail communication function according to the invention can be also added to an ordinary stationary television set. In addition, other terminals as communication parties are not limited particularly. Any optional communication device having a call function and an image-attached mail function can be used.

Although various embodiments of the invention have been described above, the invention is not limited to the matters described in the aforementioned embodiments. Changes or modifications that those skilled in the art can make based on the description of the specification and known techniques are also the intention of the invention so that these changes or modifications should be included in the scope of the invention required for protection.

The present application is based on a Japanese patent application (Patent Application No. 2005-006079) filed on Jan. 13, 2005, the contents of which are incorporated herein by reference.

### INDUSTRIAL APPLICABILITY

The invention can provide a television broadcast receiving device and a television broadcast receiving method by which a call can be answered without interrupting a broadcast program having high real-time information even when the call comes in during viewing of the program.

1. (canceled)

2. A television broadcast receiving device, comprising:
a broadcast image display portion that displays an image of a television broadcast;
a call detection portion that detects a call transmitted from another terminal; and
an audio output portion that outputs any one of sound of the television broadcast superimposed on a voice of the call, the television broadcast sound remaining after the call voice is muted, and the call voice remaining after the television broadcast sound is muted, when the call is detected by the call detection portion during televising of the television broadcast; and
an audio specifying information storage portion that stores audio specifying information for specifying the sound/voice outputted by the audio output portion,
wherein the audio output portion outputs the sound/voice specified in the audio specifying information stored in the audio specifying information storage portion when the call is detected by the call detection portion.

3. The television broadcast receiving device according to claim 1, further comprising:
a call voice storage portion that stores the muted call voice when the call voice is muted so that only the television broadcast sound is outputted by the audio output portion; and
a call voice output request portion that requests the audio output portion to output the call voice stored in the call voice storage portion,
wherein the audio output portion outputs the call voice stored in the call voice storage portion upon reception of an output request from the call voice output request portion.

4. The television broadcast receiving device according to claim 2, wherein address directory information in which identification information of calling/called terminals is registered is stored in the audio specifying information storage portion while associated with the audio specifying information; and
wherein when a call from a terminal having a phone number registered in the address directory information stored in the audio specifying storage portion is detected by the call detection portion during the televising of the television broadcast, the audio output portion outputs sound/voice specified in the audio specifying information associated with the address directory information in which the phone number is registered.

5. The television broadcast receiving device according to claim 2, wherein program information in which identification information of programs of television broadcasts is registered is stored in the audio specifying information storage portion while associated with the audio specifying information; and
wherein when a call from another terminal is detected by the call detection portion during televising of a television broadcast of a program registered in the program information stored in the audio specifying information storage portion, the audio output portion outputs the sound/voice specified in the audio specifying information associated with the program information in which the program is registered.

6. The television broadcast receiving device according to claim 2, further comprising:
a reception image display permission information storage portion that stores reception image display permission information for specifying whether to display an image received from another terminal or not;
a reception image detection portion that detects the image; and
a reception image display portion that displays the image when the image is detected by the reception image detection portion during televising of a television broadcast and the reception image display permission information stored in the reception image display permission information storage portion designates display of the image.

7. The television broadcast receiving device according to claim 6, wherein address directory information in which a mail address is registered is stored in the reception image display permission information storage portion while associated with the reception image display permission information; and
when an image received from a terminal having a mail address registered in the address directory information stored in the reception image display permission information storage portion is detected by the reception image detection portion during televising of a television broadcast and the reception image display permission information associated with the address directory information in which the mail address is registered designates display of the image, the reception image display portion displays the image.

8. The television broadcast receiving device according to claim 6, wherein program information in which identification information of programs of television broadcasts is registered is stored in the reception image display permission information storage portion while associated with the reception image display permission information; and
wherein when the image is detected by the reception image detection portion during televising of a television broadcast of a program stored in the program information storage portion and the reception image display permission information associated with the program information in which the program is registered designates display of the image, the reception image display portion displays the image.

9. The television broadcast receiving device according to claim 7, further comprising:
a transmission image display permission information storage portion that stores transmission image display permission information for specifying whether to display an image to be transmitted to another terminal or not;
a transmission image detection portion that detects the image; and
a transmission image display portion that displays the image when the image is detected by the transmission image detection portion during televising of a television broadcast and the transmission image display permission information stored in the transmission image display permission information storage portion designates display of the image.

10. The television broadcast receiving device according to claim 9, wherein address directory information in which a mail address is registered is stored in the transmission image display permission information storage portion while associated with the transmission image display permission information; and
wherein when an image to be transmitted to a terminal having a mail address registered in the address directory information stored in the transmission image display permission information storage portion is detected by the transmission image detection portion during televising of a television broadcast and the transmission image display permission information associated with the address directory information in which the mail address is registered designates display of the image, the transmission image display portion displays the image.

11. The television broadcast receiving device according to claim 9, wherein program information in which identification information of programs of television broadcasts is registered is stored in the transmission image display permission information storage portion while associated with the transmission image display permission information; and
wherein when an image to be transmitted to another terminal is detected by the transmission image detection portion during televising of a television broadcast of a program stored in the program information storage portion and the transmission image display permission information associated with the program information in which the program is registered designates display of the image, the transmission image display portion displays the image.

12. (canceled)

13. A method of receiving television broadcast, comprising:
displaying an image of a television broadcast;
detecting a call transmitted from another terminal; and
outputting any one of sound of the television broadcast superimposed on a voice of the call, the television broadcast sound remaining after the call voice is muted, and the call voice remaining after the television broadcast sound is muted, when the call is detected by the call detection portion during televising of the television broadcast;
inputting the audio specifying information for specifying the sound/voice to be outputted, in order to store the voice in advance; and
outputting the sound/voice stored in advance and specified in the audio specifying information, when the call is detected.

14. The method of receiving television broadcast according to claim 13, further comprising:
making a request for outputting of the call voice muted and stored in advance, after only the television broadcast sound is outputted with the call voice being muted; and
outputting the call voice after the output request.

15. The method of receiving television broadcast according to claim 13, wherein when a call from a terminal with a phone number registered in address directory information which is stored in advance and which includes identification information of calling/called terminals is detected during televising of a television broadcast, sound/voice specified in the audio specifying information associated with the address directory information in which the phone number is registered is outputted.

16. The method of receiving television broadcast according to claim 13, wherein when the call is detected during televising of the television broadcast of the program registered in program information which is stored in advance and which includes identification information of television broadcasts, the sound/voice specified in the audio specifying information associated with the program information in which the program is registered is outputted.

17. The method of receiving television broadcast according to claim 13, further comprising:
detecting an image received from another terminal; and
displaying the image when the image is detected during televising of a television broadcast and reception display permission information which is stored in advance and which is provided for specifying whether to display the image received from the other terminal or not designates display of the image.

18. The method of receiving television broadcast according to claim 17, wherein when reception of an image transmitted by a terminal with a mail address registered in address directory information which is stored in advance and in which a mail address is described is detected during televising of a television broadcast and the reception image display permission information associated with the address directory information in which the mail address is registered designates display of the image, the image is displayed.

19. The method of receiving television broadcast according to claim 17, wherein when reception of the image is detected during televising of a television broadcast of a program stored in program information which is stored in advance and in which identification information of programs of television broadcasts is registered, and the reception image display permission information associated with the program information in which the program is registered designates display of the image, the image is displayed.

20. The method of receiving television broadcast according to claim 18, wherein when an image to be transmitted to another terminal is detected during televising of a television broadcast, and transmission image display permission information which is stored in advance and which is provided for specifying whether to display the image to be transmitted to the other terminal or not designates display of the image, the image is displayed.

21. The method of receiving television broadcast according to claim 20, wherein when an image to be transmitted to a terminal with a mail address registered in address directory information which is stored in advance and in which a mail address is described is detected during televising of a television broadcast and the transmission image display permission information associated with the address directory information in which the mail address is registered designates display of the image, the image is displayed.

22. The method of receiving television broadcast according to claim 20, wherein when an image to be transmitted to another terminal is detected during televising of a television broadcast of a program registered in program information which is stored in advance and which includes identification information of programs of television broadcasts, and the transmission image display permission information associated with the program information in which the program is registered designates display of the image, the image is displayed.

23. The television broadcast receiving device according to claim 8, further comprising:
a transmission image display permission information storage portion that stores transmission image display permission information for specifying whether to display an image to be transmitted to another terminal or not;
a transmission image detection portion that detects the image; and
a transmission image display portion that displays the image when the image is detected by the transmission image detection portion during televising of a television broadcast and the transmission image display permission information stored in the transmission image display permission information storage portion designated display of the image.

24. The method of receiving television broadcast according to claim 19, wherein when an image to be transmitted to another terminal is detected during televising of a television broadcast, and transmission image display permission information which is stored in advance and which is provided for specifying whether to display the image to be transmitted to the other terminal or not designates display of the image, the image is displayed.
